(19) United States
(12) Patent Application Publication
(10) Pub. No.: US 2017/0064923 A1
(43) Pub. Date: Mar. 9, 2017

(54) Headwear Interface for Animals

(71) Applicant: Woojin A. Choi, Solana Beach, CA (US)

(72) Inventor: Woojin A. Choi, Solana Beach, CA (US)

(21) Appl. No.: 15/049,734

(22) Filed: Feb. 22, 2016

Related U.S. Application Data
(60) Provisional application No. 62/216,252, filed on Sep. 9, 2015.

(51) Int. Cl. A01K 13/00; A42B 1/06

(52) U.S. Cl. CPC A01K 13/006; A42B 1/062

(57) ABSTRACT

An interface is provided for the comfortable and secure positioning of a hat on the head of an animal such as a dog. The device features a body having an interior adapted to engage the head of the animal and an exterior fastened or engageable with the interior of a hat. Recesses in the body align with openings in the hat to provide a pathway for the ears of the animal therethrough. A strap is engageable around the neck of the animal and to the body or hat on opposing sides, to hold the body engaged with the hat on the head of the animal in an as-used position.

### 1. FIELD OF THE INVENTION

This application claims priority to U.S. Provisional Patent Application Ser. No. 62/216,252 filed on Sep. 9, 2015, which is incorporated herein in its entirety by this reference thereto.

The present invention relates generally to headwear. More particularly, the device relates to a headwear interface adapted for comfortable positioning on the head of an animal such as a dog, and for engagement to conventional headwear worn by humans such as caps and visors and the like, to thereby allow the dog or other animal to comfortably wear human headwear.

### 2. PRIOR ART

For centuries humans have had animals as pets, and particularly preferred by many are dogs. Over time, dogs unlike many animals have been domesticated to walk with humans and ride in vehicles calmly, and dogs generally tend to stay proximate to the human they accompany. Thus, dogs are capable of accompanying humans on virtually any outing or trip, where dogs are allowed.

During such outings, dog owners in recent times are well known to dress their animals in attire such as sweaters and the like for adornment or protection from the environment. Dog owners are also well known to place human attire on dogs to celebrate holidays, to promote a sports team, or for other reasons where a human may wish to have their dog attired in human clothing and clothing accessories.

Such clothing in order to be worn by dogs, must be adapted from a human configuration to that of a dog in the case of sweaters and such. In the case of headwear, human heads generally have a profile extending upward above the eyes the distance of the forehead. The head of most dogs lacks this upward profile and is therefor not well adapted for wearing of human headwear without some type of interface body providing a mount to hold the headwear in place. Humans who wish for their dog to wear headwear to protect the eyes of the dog from overhead sunlight or rain, or, to help promote or celebrate a sports team or event for instance, are therefor challenged in trying to place headwear made for the generally circular and vertically profiled head of a human, upon a dog.

To place headwear such as a cap or visor or other hat designed for the human head on a dog, some type of interface is required to provide a comfortable fit for the dog's head and a stable engagement of the headwear. Additionally, some type of means to maintain the hat upon the top of the head of a dog, or the interface is generally required. As dogs frequently run, jump and roll, absent some type of restraint, the hat as well as the interface will simply fall off. This problem is exacerbated when the headwear is uncomfortable and ill-fitting such as a hat simply tied to maintain it on the head of the dog, such that it would promote the dog to shake it from its head.

Further, because human headwear is designed as noted, for a head-profile much higher than that of a dog, the body of the device defining a headwear mount or interface component should include, as a means for a secure attachment of the headwear, some type of raised-profile engagement area adapted for mating to the hat. Additionally, the body of the device defining a mount or interface component must be adapted on one end to provide a comfortable fit as well as providing a sufficiently large area of contact with the head of the dog to remain stable. Still further, restraints for both the hat in its engagement to the body of the device providing the headwear mount or interface, and the hat when positioned on the head of the dog, are also preferred.

Prior art such as U.S. Pat. No. 4,969,317 and U.S. Pat. No. 5,031,388 have attempted to solve the problem of engaging headwear to animals such as dogs. However in both of these patents, the invention as taught, limits the user to a single design of a hat, which appears less than comfortable as taught, and do not provide for the employment by a user of any hat in a comfortable engagement to the head of a dog.

Another prior art patent, U.S. Pat. No. 5,893,173, (Bray) teaches the employment of a band with ties to hold a hat engaged upon the head of a dog. However the Bray reference simply teaches an annular band which is tied upon the head of a dog, but provides no manner to adapt the circumference of the first side of the band to a comfortable and secure engagement on the head of the dog, while concurrently allowing for a circumference of the opposing side of the band to engage larger, smaller or different types of hats.

As such there exists an unmet need, for a device and method providing a body forming an interface for the comfortable engagement of a human hat or cap or visor or the like, on the head of a dog. Such a device should provide for easy engagement and disengagement of a wide variety of headwear in a wide variety of styles, securely, on one end of the body providing the interface. Further such a device should be adapted to be operatively positionable on the head of a dog with both comfort and stability. Such a device and method should provide for a secure and comfortable engagement of the body providing the mount for hat engagement, which a configuration adapted to contact a sufficiently wide surface area of the head of the dog to provide a stable and comfortable engagement, and to thereby minimize attempts by the dog to remove it. This engagement between the body of the device and the head of the animal should be adapted to maintain the body forming the headwear mount on the head of a dog during running, jumping, and other normal movements of the dog.

The forgoing examples of related art and limitation related therewith are intended to be illustrative and not exclusive, and they do not imply any limitations on the invention described and claimed herein. Various limitations of the related art will become apparent to those skilled in the art upon a reading and understanding of the specification below and the accompanying drawings.

### SUMMARY OF THE INVENTION

The device herein disclosed and described provides a solution to the shortcomings in prior art and achieves the above noted goals through the provision a body component providing a hat interface configured for positioning and engagement between the head of a dog, and between hats, visors, and the like, which are originally designed for positioning on the human head. In another mode of the device, the body of the device can be included or subsequently engaged with a hat or headwear which is pre-configured to the anatomy of the head of the dog, including an accommodation for the ears and their position.

The device in all modes includes a body component configured to maintain the circumference of a hat expanded and engaged, and to maintain the position of the hat upon the head of the animal or dog. The body is formed of material which may be pliable and flexible but will maintain the circumference of the hat in an annular or circular configuration and on the body which is concurrently engaged on the head of the animal, such as plastic or polymeric materials. The body is configured on a lower or first side, in a shape and configuration which accommodates the head shape and ears of a dog, and in doing so provides for a comfortable yet secure positioning of the lower or first side of the body, upon the head of a dog. The exterior circumference of the body providing this interface, includes a sidewall configured for operative and secure engagement to headwear either generally configured for humans, but with openings adapted to allow for ear passage.

The body may be formed partially, or entirely of fabric, foam material, plastic, or polymeric material, depending on the configuration and preference of the user. If formed entirely of foam, a closed cell foam would provide a pliable yet shape-holding structure defining the body, which on the first side would be pliable and adapted to conform to the surface of the head of a dog. The body in a unitary or formed structure, could be formed in a planar or walled configuration from polymeric or plastic material, with the first side is similarly configured to be complimentary to the shape of the head of a dog, when this mode of the body is engaged within the circumference of a hat or headwear. It should be noted the body need not be a complete circle or annular configuration but could be formed with components forming the body which are enageable with the hat to maintain hat shape and maintain it on the dog or animal head.

In preferred modes of the device, on the exterior surface of the body communicating between the first and the second side, the exterior circumference would be formed such that it is approximately equal to or slightly smaller than the interior circumference of a headwear to be engaged thereto, adjacent the lower edge of the had. Many such hats are adjustable in circumference so forming the circumference of the second side of the annular body to an industry medium will allow for most adjustable-sized hats to be sized to engage the circumference of the second side. When the body is formed with vertically disposed sidewalls, openings may be provided along opposing edges of the first side to accommodate the ears of a dog.

The body may also be formed of two types of material such as forming a second side and the sidewall circumference from a plastic or similar material and forming the first side and interior portion of foam or memory foam to allow for a pliable and comfortable conforming of the first side and interior to the head of the dog. Other configurations or anticipated where the second side may rise to a dome or in a similar fashion to that of a human head, or for example a first side and interior surface within the sidewall is formed of pliable material such as open or closed cell foam, but contoured to generally conform to the shape of the head of a dog.

Engagement of the body to the head of the dog once the first side is positioned thereon, will preferably be augmented by a first set of straps engaged with opposite sides of the sidewall or other part of the body, or flexible members or straps engaged to the hat which operatively engages the sidewall. Distal ends of the this first set of straps will include complimentary engaging fasteners to allow engagement of both to each other under the neck of the dog; or, the straps may be a continuous elastic band with no distal ends. It is preferable that second or rear straps may also be provided on both sides of the device, which communicate between the first set of straps and a rearward position on the body of the device to provide extra support and stability.

Engagement of headwear such as a baseball cap, visor, or other hat to the second side or circumference of the formed body can simply be accomplished by adjusting the size of the headwear to a very tight frictional engagement of the circumference of the sidewall of the body adjacent the second side. Alternatively, clips providing a biased contact with the headwear, or engageable fasteners such as snaps, hook and loop fabric, or magnets may be employed to maintain the headwear on the second side of the body of the device. In addition, the body may be directly stitched or otherwise directly attached into the inner crown of the headwear.

In a preferred mode of the device, the body can be formed of substantially planar material which as noted includes open edges or cut outs on the first side to accommodate the ears of a dog. This planar body can engage with or into conventional headwear, or in a more preferred version, it will engage with headwear also having openings in the side edges of the headwear requiring the second side of the device to be configured accordingly such that it follows the path of the inner crown inside such headwear. In this mode the body can be engaged with the headwear using snaps, hook and loop fabric, or by sewing the body into the interior circumference of the headwear.

It should be noted that the choice of overall size and shape of the body interfacing between the headwear and animal head may be altered from that which is shown herein and still be within the scope of this application. Such changes may be determined by factors such as cost to manufacture, the size and the shape of the hat and dog's head, the need for ventilation and other user preferences and requirements to comfortably and securely fit on the head of any of the many breeds of dogs which can vary widely between large dogs and lap dogs.

Additionally, the surface of either the first or second side of the body and the circumference or sidewall may also be modified (e.g. perforated, ribbed, textured, etc.) to enhance aesthetics and function such as ventilation, grip, weight, firmness and the like. Further, while this application describes the device herein with regard to having a formed body acting as an interface component for positioning between dogs and headwear, the device may be adapted as an interface for engagement of headwear to virtually any animal, and such is anticipated within the scope of this application.

It should be further noted, headwear and hats as used herein, is not limited to headwear worn by humans, but can be any functional or ornamental object. One example, is the application of the device to hats that are similar to but smaller or larger than hats made for humans, where the size of the animal (e.g. puppies and small dog breeds like Chihuahuas) prevents the use of standard human-sized hats.

Still further, is briefly noted that upon a reading this disclosure, those skilled in the art will recognize various other means for carrying out these intended features of the invention. As such it is to be understood that other methods, applications and systems configured to provide an interface between headwear and the head of an animal may be configured to carry out these features and are therefor considered to be within the scope and intent of the present invention, and are anticipated.

With respect to the above description, before explaining at least one preferred embodiment of the herein disclosed invention in detail, it is to be understood that the invention is not limited in its application to the details of construction and to the arrangement of the components or steps noted in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other interface components for positioning between hats and animals, and methods and systems for carrying out the several purposes of the present disclosed device. It is important, therefore, that the claims herein be regarded as including such equivalent construction and methodology insofar as they do not depart from the spirit and scope of the present invention.

The objects features, and advantages of the present invention, as well as the advantages thereof over existing prior art, which will become apparent from the description to follow, are accomplished by the improvements described in this specification and hereinafter described in the following detailed description which fully discloses the invention, but should not be considered as placing any limitations whatsoever thereon.

### BRIEF DESCRIPTION OF DRAWING FIGURES

The accompanying drawings, which are incorporated herein and form a part of the specification, illustrate some, but not the only or exclusive, examples of embodiments and/or features. It is intended that the embodiments and figures disclosed herein are to be considered illustrative rather than limiting.

In the drawings:

FIG. 1 depicts the device herein in an as-used position, secured with a first side positioned on the head of a dog, and with headwear operatively engaged upon a second side of the body of the device.

FIG. 2 is a perspective view of one mode of the device herein showing the second surface and sidewall of the body having securement straps engaged adjacent the first side, and hat retaining clips positioned adjacent the second side.

FIG. 3 depicts a graphic depicting of headwear in the form of a baseball cap, engaged about the sidewall defining the circumference of the second side of the body, and showing side portions of the hat sandwiched in-between biasing clips and the sidewall.

FIG. 4 is a view of a mode of the body showing the first side of the body having foam or memory foam therein, and the exterior and second side of the body formed of another material adapted for secure engagement to a hat.

FIG. 5 depicts another mode of the body wherein securement straps are secured through apertures formed in the exterior sidewall and a fastener is positioned on the body of the device which is complimentary and engaging with a fastener positioned on a hat.

FIG. 6 depicts the device as in FIG. 5 in an as-used position with the body having a first side engaged on the head of a dog, and the hat secured about the sidewall circumference and held by the complimentary fasteners on both the hat and the body of the device.

FIG. 7 depicts another mode of the device wherein the body is formed in a substantially annular configuration similar to the shape of a hat such as in FIG. 8, and showing recesses formed in the first side edge and fasteners which are complimentary to fasteners of the headwear for securement.

FIG. 8 depicts an overhead sectional view of a planar configuration of the device which may be engaged within the interior circumference of headwear as in FIG. 7 or 9 and 11.

FIG. 9 depicts headwear engaged upon the exterior of the body of the device such as that in FIG. 7, and showing the securing straps and ear cutouts formed in the body of the device.

FIG. 10 is a depiction of the more planar mode of the body of the device, showing an insertion thereof into headwear having cutouts registering with those of the body being inserted, or sewn into the headwear.

FIG. 11 depicts the device as in FIG. 10, operatively engaged upon the head of a dog using the securement straps and showing the cut-out or opening of the body in registered positioning with that of the headwear.

FIG. 12 shows the body of the device which engages with a hat formed in multiple components.

FIG. 13 depicts the device as in FIG. 12 with the body components depicted in FIG. 12, operatively engaged with the hat.

FIG. 14 shows the body formed in half sections which engaged with the hat only at front and rear positions on opposite sides of the gap formed in the hat.

FIG. 15 depicts an overhead bottom view showing the device as in FIG. 14 engaged within the hat.

FIG. 16 shows the straps for the hat engaged with the lower edge of the hat.

FIG. 17 depicts the straps for the hat engaged with the body which engages with the circumference of the hat adjacent the lower edge of the hat.

FIG. 18 shows that strap engagement points can be provided on the hat or the body, for the user to employ their own straps such as the depicted strap apertures.

Other aspects of the present interface device for headwear and animals shall be more readily understood when considered in conjunction with the accompanying drawings, and the following detailed description, neither of which should be considered limiting.

### DETAILED DESCRIPTION OF THE PREFERRED EMBODIMENTS OF THE INVENTION

In this description, the directional prepositions of up, upwardly, down, downwardly, front, back, top, upper, bottom, lower, left, right and other such terms refer to the device as it is oriented and appears in the drawings and are used for convenience only. Any such terms are not intended to be limiting or to imply that the device has to be used or positioned in any particular orientation.

Now referring to drawings in FIGS. 1-18, there is seen in FIG. 1 one preferred mode of the headwear interface device 10 herein, shown in as-used position, where the body 12 proving this interface, is positioned with a first side 14 operatively positioned on the head of an animal such as a dog 15. Headwear such as headwear or a hat 16 operatively engaged about an exterior sidewall 18 defining a circumference of the body 12 adjacent a second side 20 of the body 12.

Also shown are a first set of straps 22 engaged to the body and extending to distal ends having cooperatively engageable fasteners 24. Secondary straps 26 are provided extending between an engagement to the body 12 at a first end and one each of the first set of straps 22. This strap configuration is preferred in all modes of the device 10 in that it provides a V-shaped securement of the body 10 to the head and thereby provides a secure mount and prevents the body 12 from dismounting to the front or rear of the head during sudden movements.

As can be discerned, the complimentary engaging fasteners 24 removably connect the opposing distal ends of the first set of straps 22 under the neck of the dog 15, and along with the secondary straps 26 if provided, hold the first side 14 of the body 12 operatively positioned on the head of the dog 15.

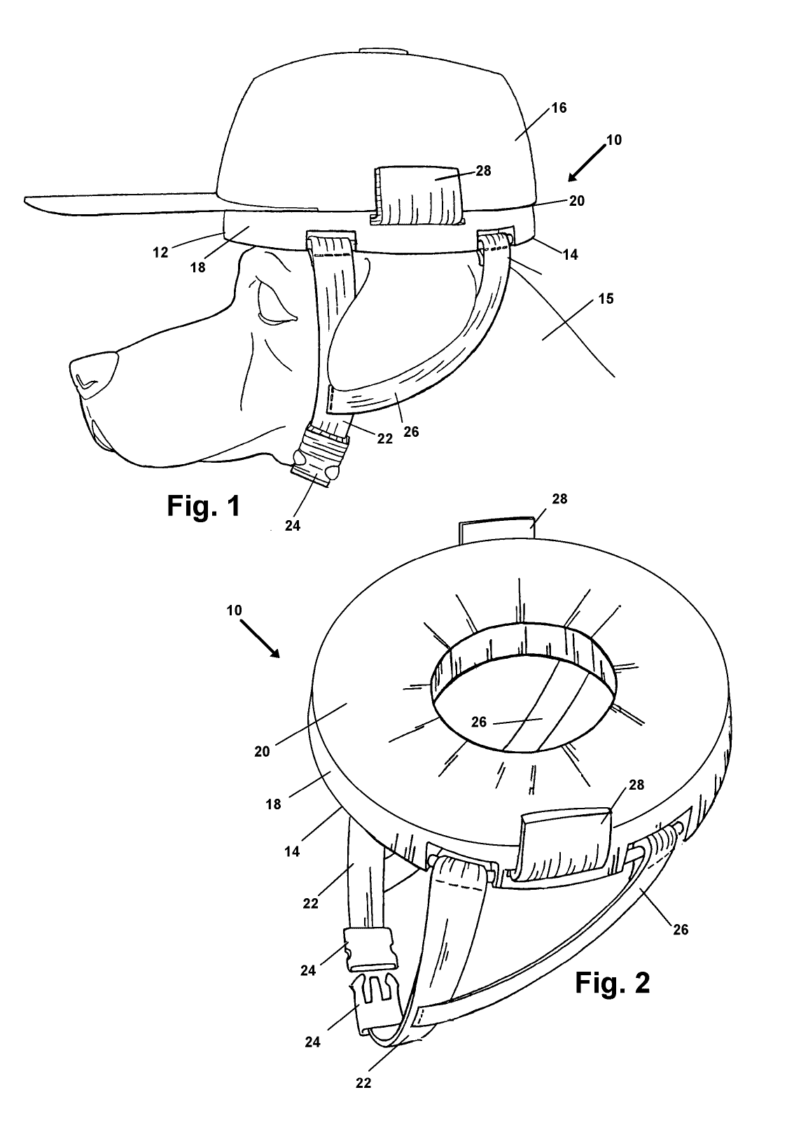

The depiction in FIG. 2 shows a perspective view of one mode of the device 10 as in FIG. 1, showing the second side 20 of the body 12 intersecting the sidewall 18 which defines the circumference of the body 12 which is adapted for engagement of a hat 16 thereon. The first set of securement straps 22 are shown with cooperative fasteners 24 disengaged, and second set of securement straps 26 operatively positioned.

Also shown are one current preferred securing fastener for the hat 16 in the form of retaining clips 28 engaged with the body 12 and extending in the direction of the sidewall 18. The interior surface of the retaining clips 28 is sufficiently proximate to the sidewall 18 to form a gap smaller than the thickness of the hat 16 such that a biased sandwiched engagement of the edge of the hat 16 between the surface of the clip 28 and the sidewall 18 is achieved to hold the hat 16 in position. This mode of securing fastener works well with human headwear as well as headwear with side openings as in FIG. 10.

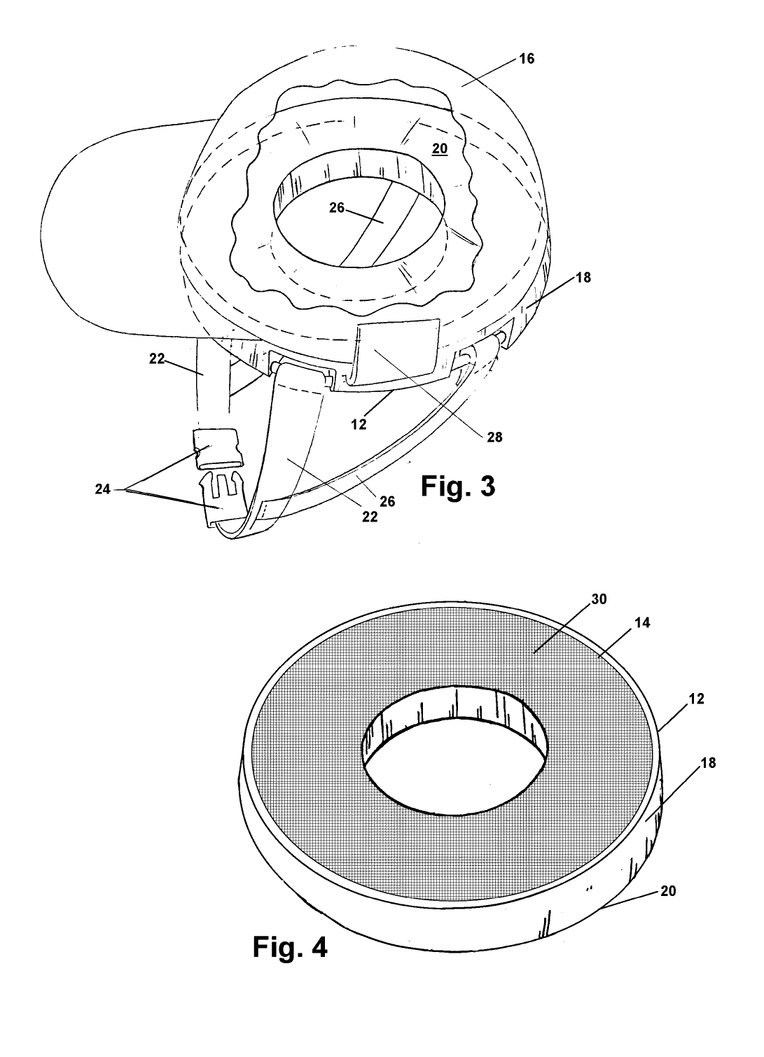

Shown in FIG. 3 is a depiction of this biased frictional engagement of the headwear such as a hat 16 engaged about the sidewall 18 defining the circumference of the body 12 adjacent the second side 20 of the body 12. The sandwiched engagement of side portions of the hat 16 sandwiched the gap in-between the clips 28 and the sidewall 18 is also shown.

In the depiction of FIG. 4 is shown a view of the first side 14 of a body 12 in a mode of the device 10 featuring foam 30 such as open or closed cell type foam or memory foam forming an interior portion of the body 12 on the first side 14 thereof. This provides an interior surface adapted for conforming engagement to the contours of the head of an animal such as a dog 15. The foam 30 of course may be non planar and formed in a contoured recess on the first side 14 of the body 12, or in other modes where the surface of the first side 14 of the body 12 will comfortably conform and/or adapt to the contours and shape of the animal such as a dog 15 on which the body 12 of the device 10 is engaged. Further, the annular shape of the horizontal cross section of the body 12 may be uniform as depicted (constant R minus r) or vary along the circumference of the body 12 in order to accommodate the ears and other features of the dog's head 15.

Also shown in FIG. 4 is a configuration of the body 12 where all or a portion of the sidewall 18 and the second side 20 of the body 12 are formed of material different than that of the first side 14 of the body and the interior of the body 12 adjacent the first side 14. For example the sidewall 12 can be formed of material stiffer than that of foam such a polymeric material or plastic which is pliable, but will retain the size of the circumference defined by the sidewall 12 for more secure engagement thereof to hats 16.

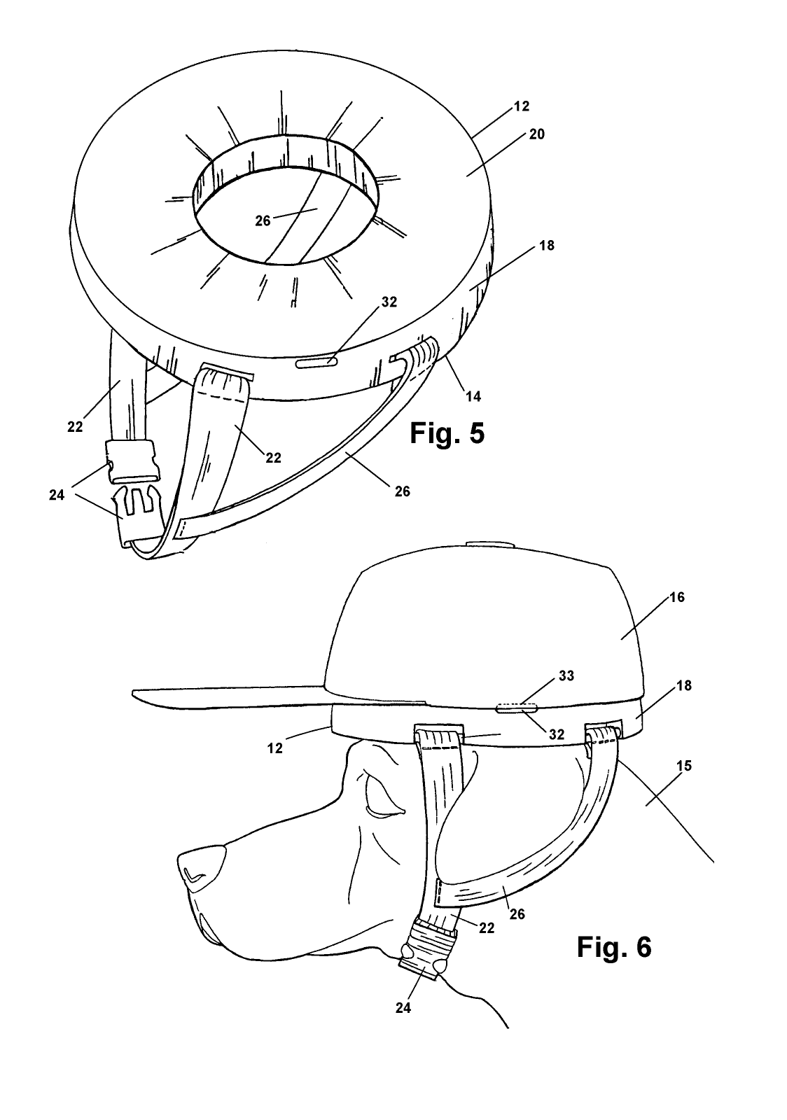

FIG. 5 also depicts another mode of a securing fastener 32 positioned on the body 12, in a registered position to engage with a mating securing fastener 33 positioned on a hat 16. Such securing fasteners 32 and 33 may be any complimentary fastener where two halves thereof easily engage and disengage to allow easy mounting and dismounting of a hat 16 to the body. For example such securing fasteners 32 and 33 can be one or a combination of securing fasteners from a group including snaps, buttons, clips, magnets, grommets, hook and loop fabric, or other securing fasteners as would occur to those skilled in the art for removable securement of the hat 16 to the body 12.

Shown in FIG. 6 is a mode of the device 10 as in FIG. 5 where the body 12 is positioned in an as-used position, with the body having a first side 14 comfortably and securely positioned on the head of an animal such as a dog 15. The headwear such as the depicted hat 16, is shown secured about the sidewall 18 defining the body circumference, and held in this position by the cooperatively engaged complimentary fasteners 32 and 33 respectively located on the body 12 of the device 10 and a hat 16.

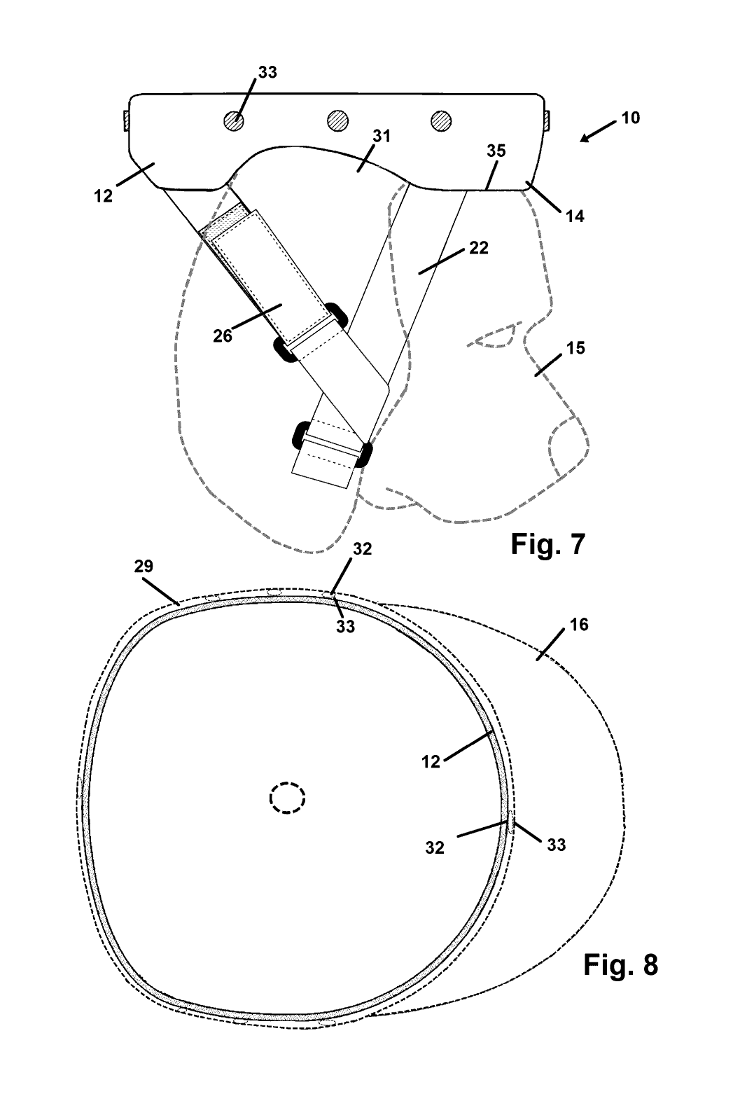

In FIG. 7 is depicted another mode of the device 10 positioned in an as-used position with the first side 14 of the body 12 engaged upon the head of a dog 15. The first set of straps 22 are secured as noted above, and secondary straps 26 are provided communicating between the rear of the body 12 and the first set of straps 22.

As depicted in FIG. 7 as in other modes of the body 12 shown herein, the body 12 is formed in a circular or substantially annular configuration, similar to the shape the side 29 of a hat 16 (FIG. 8). Also shown in FIG. 7, but applicable to all modes of the body 12 herein, are recesses 31 or gaps or openings, formed into the edge 35 of the first side 14 of the body 12. Additionally shown are securing fasteners 32 which are complimentary and removably engageable with mating securing fasteners 33 (FIGS. 8 and 10) of the headwear or hat 16 and thereby used for removable securement of the hat 16 to the body 12.

FIG. 8 shows an overhead sectional view of a planar configuration of the body 12 of the device 10. As noted, this mode of the device 10 being thinner may be hidden from view with the device 10 in the as-used position and engaged within the interior circumference of headwear such as a hat 16 as in FIG. 7 or 9 and 11. Also shown are the mating securing fasteners 33 which are engaged or affixed to the interior of the hat 16 which are removably engaged upon the securing fasteners 32 on the body 12 of the device.

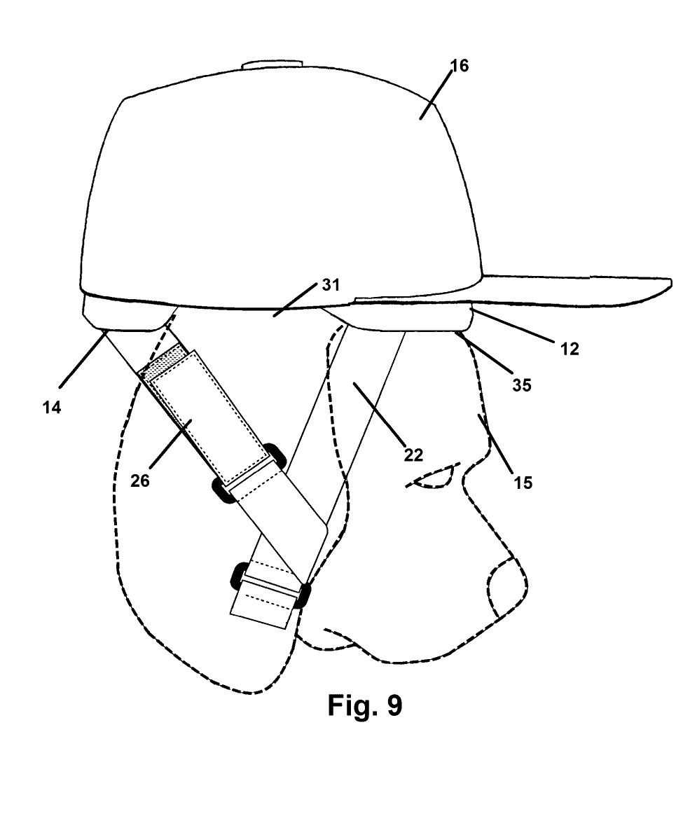

FIG. 9 depicts the headwear such as a hat 16, engaged upon the exterior of the body 12 of the device 10 such as that in FIG. 7 and showing the body 12 in the as-used position, and the hat 16 removably engaged with the body 12. As can be seen, the recess 31 at opposing edges 35 of the first side 14 of the body 12, provide a pathway for comfortable communication of the ears of the dog 15. The body 12 so mounted with the first set of straps 22 and secondary strap 26, is especially secure and it has been found that providing the pathway for the ears using the recesses 31, increases the secure positioning by preventing rotation of the body 12 and hat 16 on the head.

Shown in FIG. 10 is a depiction of the more planar mode of the body 12 of the device 10 herein. In FIG. 10 is depicted the ability to pre-insert, or engage the body 12 within the interior circumference of the hat 16. The body 12 in this mode can be permanently engaged within a pocket or by sewing into the interior circumference of the hat 16, or, it may be removably engaged by insertion into hat 16 and engagement of the securing fasteners 32 with the mating securing fasteners 33.

Additionally shown in FIG. 10, is a particularly preferred mode of the device 10 and system herein, wherein the opposing sides of the hat 16, have openings 36 formed therein. These openings 36 are complimentary in shape to the recesses 31 formed into the body 12 of the device to be engaged in the hat 16.

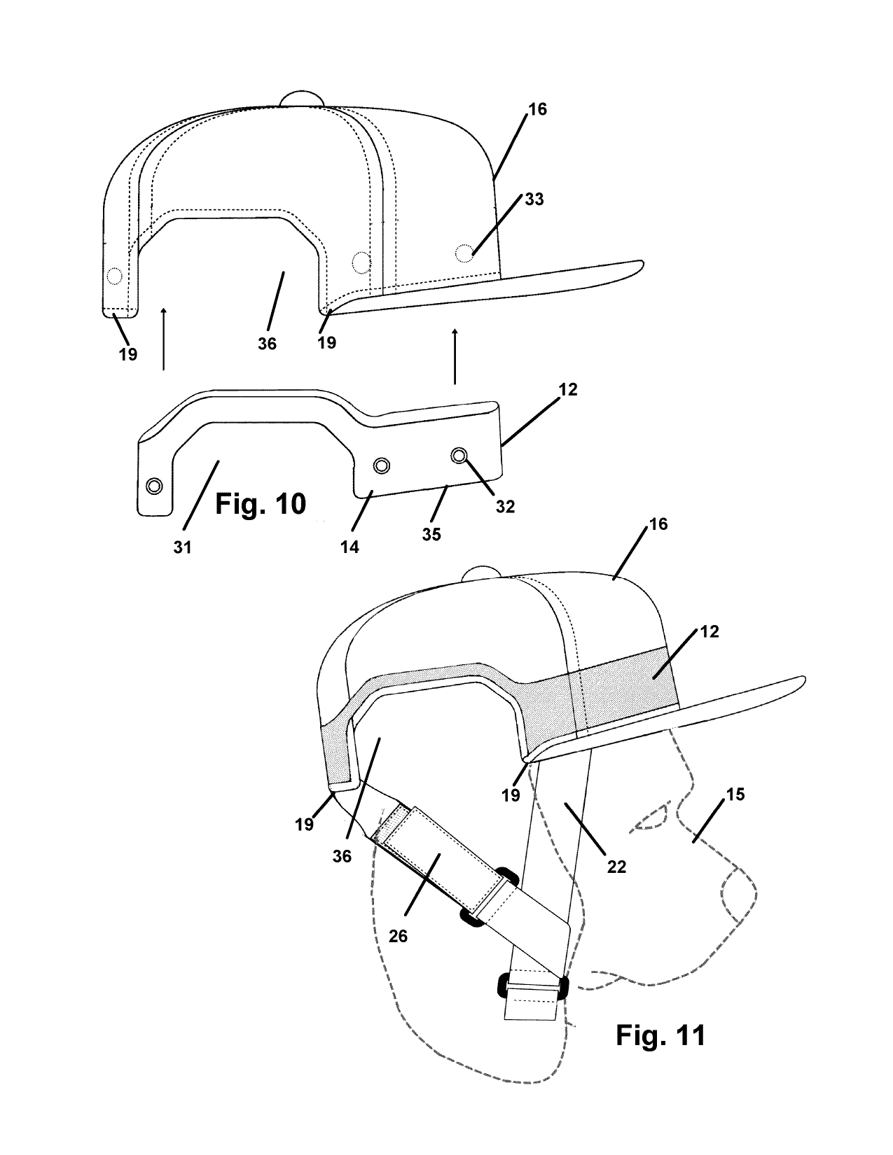

In use to form the support to maintain the hat in a substantially circular configuration upon the head of the animal, the body 12 is positioned into the hat 16 with the openings 36 registered in position adjacent the recesses 31. This provides an especially preferred pathway for the ears of a dog 15 or animal wearing the hat 16 with the body 12 of the device 10 secured to hold the shape and positioning of the hat 16 when positioned on the head of a dog 15 or animal, as in FIG. 11.

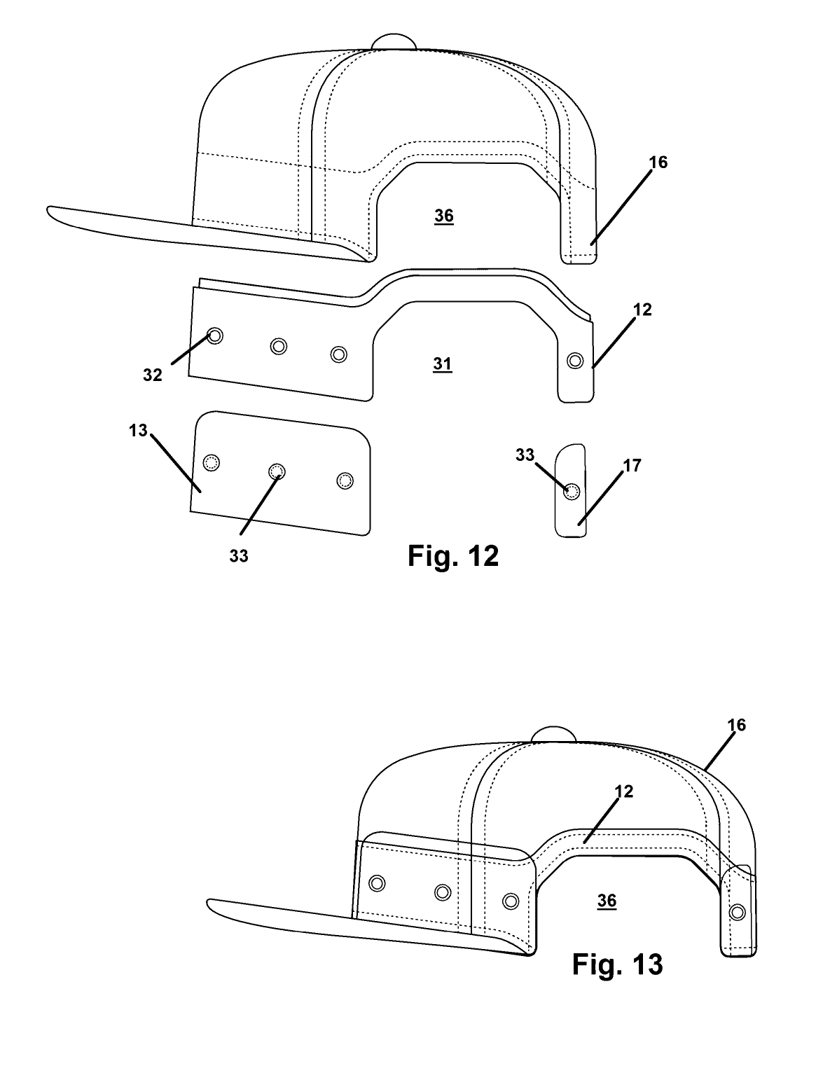

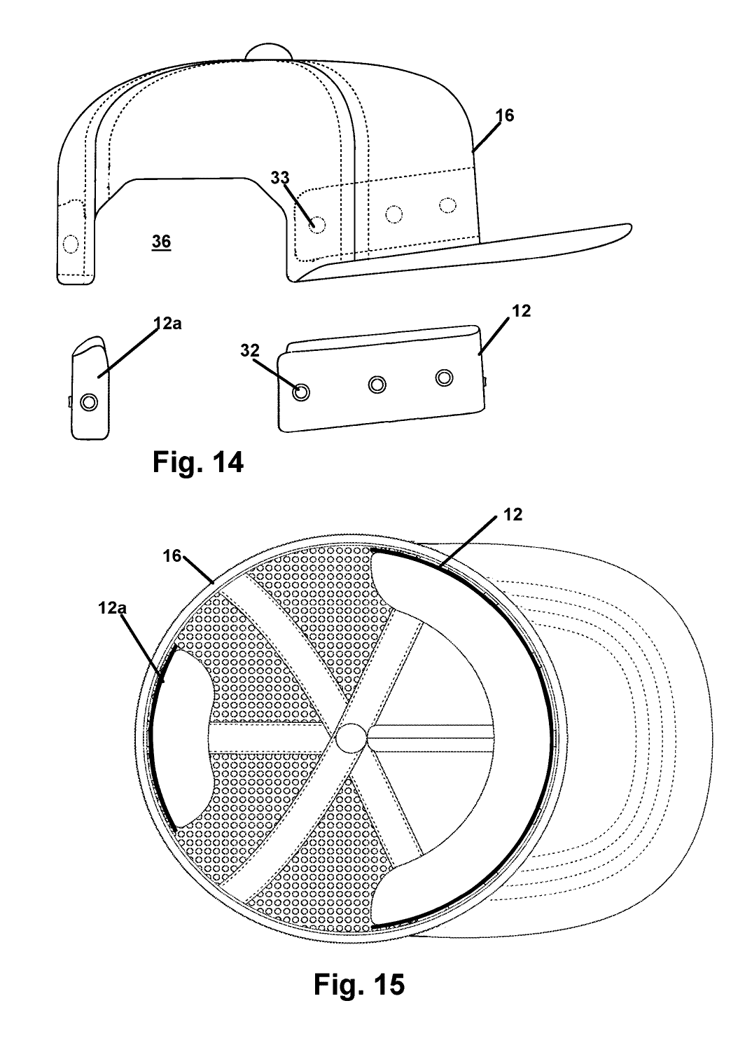

Further, while the body 12 providing the support for the circumference of the hat 16 is shown in a single annular component in FIG. 10, this should not be limiting as the body 12 can be formed in multiple components such as in FIGS. 12-13 to support the hat circumference, or can be formed such as in FIGS. 14-15 where multiple components forming the body 12 are engaged to the hat 16 on opposing sides of the openings 36, and support the shape of the hat circumference by a curved shape and engagement to front and rear portions of the hat 16 on opposing sides of the openings 36.

As noted, FIG. 11 depicts the body 12 as in FIG. 10, operatively engaged in an as-used position, attached to the circumference of the hat 16 adjacent a lower edge 19 with defines the circumference and opening of the hat 16 into which the head of a dog 15 is operatively positioned. The hat 16 may be provided in combination with the body 12 formed as a single annular component or multiple components, or since the body 12 in all modes is adapted to engage the circumference of the hat 16 adjacent the lower edge 19, users can form openings 36 to fit their animal or dog 15, and then engage the body 12 by engagement of the securing fasteners 32 on the body 12 to mating securing fasteners 33 which can be positioned in a hat 16 by the user. Means for positioning the mating securing fasteners 33 are shown in FIGS. 12 and 14. Other means for positioning of the mating securing fasteners 33 can be employed such as adhesive, pins, clips, or the like, so as to allow a mating fastener engagement of the securing fasteners 32 to mating securing fasteners 33, to thereby hold the body 12 to the hat 16.

Additionally shown in FIG. 11 are the first set of straps 22 are secured under the neck, and the secondary straps 26 extend between the rear of the body 12 to the first set of straps 22. These straps 22 and 26, may be secured to the body 12 such as in FIG. 17, in modes of the device herein where the body 12 is engaged to a hat 16 using a mating fastener engagement. This will allow any hat 16 to be used and mated with the body 12.

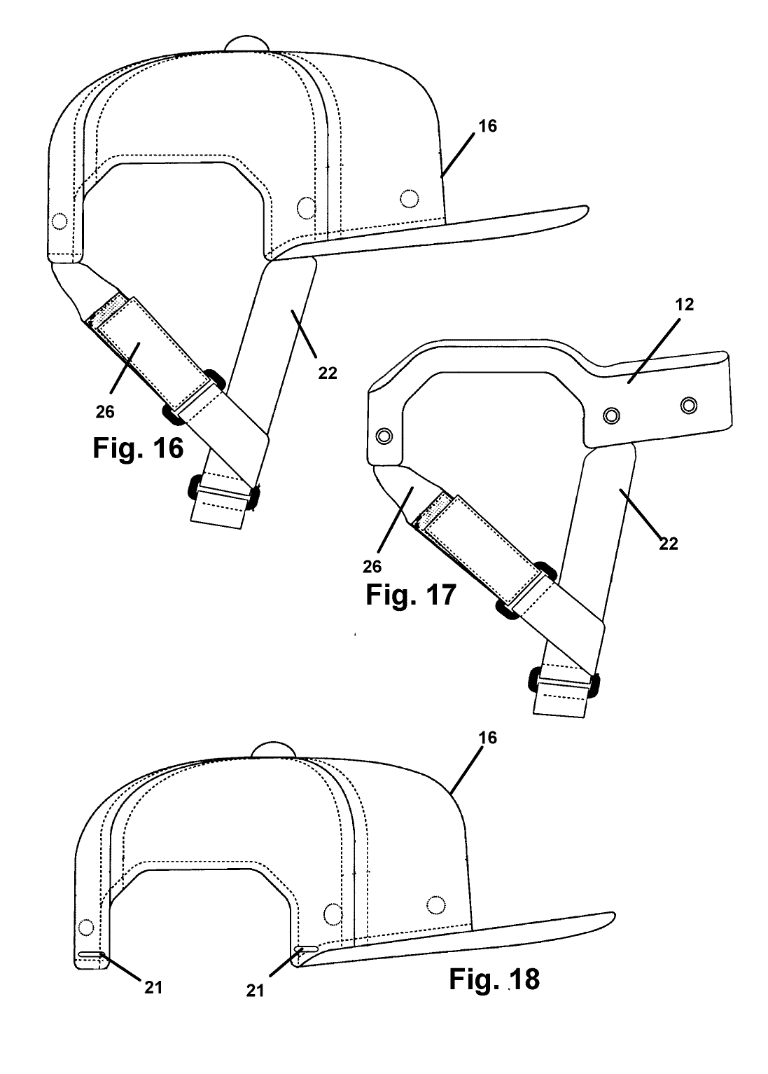

Alternatively the straps 22 and 26 can be engaged to a hat provided in combination with a body 12 such as shown in FIG. 16 where the straps 22 and 26 may be permanently or removably engaged adjacent the lower edge 19 of the hat 16. Further, either the body 12 or the hat 16 itself if provided, can include engagement positions adapted for engagement of straps 22 and 26 such as the strap apertures 21, shown in FIG. 18 in the hat 16 but which can be formed in the body 12.

FIG. 12 shows another mode of the device and system herein, which includes hat-positioned mounts 13 which have mating securing fasteners 33 positioned thereon. The mounts 13 provide one way to securely position the mating securing fasteners 33 in the hat 16 such that they may engage with the securing fasteners 32 on the body 12. The mounts 13 may be engaged to the hat 16 with adhesive, clips, pins, snaps, or other fasteners adapted to connect the mounts 13 with the hat 16.

Shown in FIG. 13 is the device and system herein with the mount 13 engaged with the hat 16, and the body 12 engaged to the hat 16 through the engageable mating fasteners provided by the securing fasteners 32 and mating securing fasteners 33.

FIG. 14 as noted, shows that the body 12 can be formed in half sections shown as 12 and 12a, which are operatively engaged with the hat 16 at front and rear positions shown in FIG. 15, on opposite sides of the opening 36.

As noted, FIG. 15 depicts an overhead bottom view showing the body components as in FIG. 14 engaged within the hat 16.

As noted above, FIG. 16 shows the straps 22 and 26, to hold the hat 16 and with engaged body 12 on the animal, can be engaged at or adjacent the lower edge 19 of the hat 16.

FIG. 17 depicts the straps 22 and 26 engaged with the body 12 which as noted engages with the circumference of the hat 16 at or adjacent the lower edge 19 of the hat 16.

Finally, FIG. 18 shows that strap engagement points can be provided on the hat 16, or the body 12, such as the depicted strap apertures 21, whereby user may employ their own straps 22 and 26.

In a method of employing the device 10 herein, a user would form headwear such as a baseball cap to include openings in both sides of the cap extending toward the top of the cap from a lower edge.

While all of the fundamental characteristics and features of the interface device allowing for comfortable and secure engagement of headwear to animals such as dogs, have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention. Consequently, all such modifications and variations and substitutions are included within the scope of the invention as defined by the following claims.

What is claimed is:

1. An apparatus for positioning of a hat on the head of an animal such as a dog, comprising:
a body having an interior surface opposite and exterior surface, said body positionable to an as-used position on the head of said animal, with a hat engaged with said exterior surface, and said interior surface adjacent a head of said dog; and
a strap engaged with one of said body or said hat for maintaining said body with said hat engaged thereto, upon said head of said dog.

2. The apparatus for positioning of a hat of claim 1, additionally comprising:
recesses extending into said body from a lower edge thereof on opposite sides of said body;
each of said recesses positioned to register in an aligned position with a respective opening formed in said hat while engaged with said exterior surface; and
pathways formed through each recess and a respective aligned opening, each said pathway providing a path for communication of a respective ear of said animal therethrough, while said body is positioned in said as-used position.

3. The apparatus for positioning of a hat of claim 1 wherein said hat is engaged with said exterior surface of said body by securing fasteners positioned on said body in positions to removably engage with mating securing fasteners positioned within an interior of said hat.

4. The apparatus for positioning of a hat of claim 2 wherein said hat is engaged with said exterior surface of said body by securing fasteners positioned on said body in positions to removably engage with mating securing fasteners positioned within an interior of said hat.

5. The apparatus for positioning of a hat of claim 3 wherein said securing fasteners include one or a combination of securing fasteners from a group of fasteners including snaps, buttons, clips, magnets, grommets, hook and loop fabric.

6. The apparatus for positioning of a hat of claim 4 wherein said securing fasteners include one or a combination of securing fasteners from a group of fasteners including snaps, buttons, clips, magnets, grommets, hook and loop fabric.

7. The apparatus for positioning of a hat of claim 1 additionally including:
a hat;
recesses extending into said body from a lower edge thereof on opposite sides of said body;
each of said recesses positioned to register in an aligned position with a respective opening formed in said hat while engaged with said exterior surface; and
pathways formed through each recess and a respective aligned opening, each said pathway providing a path for communication of a respective ear of said animal therethrough, while said body is positioned in said as-used position.

8. The apparatus for positioning of a hat of claim 7 wherein said hat is engaged with said exterior surface of said body by securing fasteners positioned on said body in positions to removably engage with mating securing fasteners positioned within an interior of said hat.

9. The apparatus for positioning of a hat of claim 2 additionally comprising:
said body being a planar annular ring having a circumference sized for positioning within a circumference of a head opening of said hat.

10. The apparatus for positioning of a hat of claim 4 additionally comprising:
said body being a planar annular ring having a circumference sized for positioning within a circumference of a head opening of said hat.

11. The apparatus for positioning of a hat of claim 6 additionally comprising:
said body being a planar annular ring having a circumference sized for positioning within a circumference of a head opening of said hat.

12. The apparatus for positioning of a hat of claim 3 wherein said body is formed of a first body component and a second body component;
said first body component positioned at a front portion of said hat from which a bill extends; and
said second body component positioned at a rear portion of said had opposite said front portion.
